(19) United States
(12) Patent Application Publication
(10) Pub. No.: US 2006/0200404 A1
(43) Pub. Date: Sep. 7, 2006

(54) Trading system having a market depth tool with dynamic price axis

(76) Inventor: Franklin R. Stearns, Libertyville, IL (US)

Correspondence Address: MAYER, BROWN, ROWE & MAW LLP, P.O. BOX 2828, CHICAGO, IL, 60690-2828, US

(21) Appl. No.: 11/367,689

(22) Filed: Mar. 3, 2006

Related U.S. Application Data
(60) Provisional application No. 60/658,944, filed on Mar. 4, 2005.

(51) Int. Cl. G06Q 40/00

(52) U.S. Cl. 705/37

(57) ABSTRACT

A trading system having a graphical user interface having a first axis showing a plurality of prices for a given trading vehicle, a second axis showing a plurality of bids corresponding to the prices on the first axis, a third axis showing a plurality of asks corresponding to the prices on the first axis and a convergence point on said graphical user interface, wherein when there is a change in the inside market, said first axis moves so that the price associated with the inside market gradually becomes aligned with said convergence point.

This application claims priority to U.S. Provisional Patent Application No. 60/658,944, filed Mar. 4, 2005, incorporated herein by reference.

### FIELD OF INVENTION

This invention relates generally to electronic trading of investment vehicles, such as stocks, bonds or commodities, and in particular an electronic trading system with a graphical user interface having a market depth tool with a dynamic price axis.

### BACKGROUND OF INVENTION

Present trading systems contain numerous ways of displaying the depth of a market for a particular trading vehicle, such as a commodity. These systems either anchor inside market prices to a central axis, or move market depth along a static display of ordered prices. Users of the former type of system run the risk that an instantaneous change in price that occurs simultaneously with a command to submit or pull an order may result in an unwanted execution of the order (either a buy or sell) at an undesired price. In the latter type of system, the inside market prices can easily drift off the user's screen when the range of prices on screen no longer correspond to any prices in the inside market, thereby requiring a user to execute a recentering command. Accordingly, there is a need for an improved market depth trading tool that addresses the disadvantages of existing systems. Other needs will become apparent upon reading the following description, taken in conjunction with the drawings.

### SUMMARY OF THE INVENTION

The trading system of one embodiment of the present invention provides a graphical user interface having a market depth convergence tool that provides single-click order entry and order cancellation functionality, preferably with a single click of a user input device, such as a computer mouse or computer key, and provides flexible and configurable mechanisms for automatically centering the central market price (i.e., the inside market price) upon a specified point within a graphical display area. With the convergence tool of one embodiment, the values in the price axis dynamically and gradually move back towards a set “convergence point” in a graphical display area when the central market price changes. This allows the market depth automatically to move towards a pre-defined location on a graphical interface in a smooth and gradual manner, as defined by the system user, and move back towards a location that exists on the trader's field of vision on the screen. This convergence can be gradual or instantaneous, depending on the trader preferences. An instantaneous convergence will anchor the central market price on the convergence point in such a way that market depth is static and market prices will change automatically to adjust for changes in the central market price. While some traders prefer this type of display and trading interface, it is possible that the central market price can move just milliseconds before a trader sends in a buy or sell order into the market. In this case the trader risks buying or selling at a level other than his or her intended price. A gradual convergence of the central market price upon the established convergence point provides the benefit, among others, of automatically aligning the central market price to the convergence point without the risks associated with an instantaneous shift in underlying price levels in the trading interface. Users of the present invention are thus able to set the velocity of this convergence at a level with which they are comfortable. Other advantages and features of the present invention will become apparent in view of the description below, taken in conjunction with the drawings.

### BRIEF DESCRIPTION OF THE DRAWINGS

FIG. 1a shows a portion of a representative computer screen with a graphical user interface having a market depth convergence tool according to one embodiment of the present invention.

FIG. 1b shows a portion of a representative computer screen with a graphical user interface having a market depth convergence tool according to one embodiment of the present invention together with areas of the screen having other interfaces and tools for the display of data to the user and for setting of various user-determined operating parameters.

FIG. 2 shows a progression of movement in the graphical user interface of FIG. 1.

FIG. 3 shows a progression of movement in another graphical user interface with a market depth convergence tool according to one embodiment of the present invention.

FIG. 4 shows another progression of movement in the graphical user interface of FIG. 3.

FIG. 5 shows a high-level flow diagram of the functionality of the trading system of one embodiment of the present invention.

FIG. 6 shows a flow diagram of the “monitoring” process of the trading system of one embodiment of the present invention.

FIG. 7 shows a flow diagram of the “force converge” process of the trading system of one embodiment of the present invention.

FIG. 8 shows a flow diagram of the “adjust CMP” process of the trading system of one embodiment of the present invention.

FIG. 9 shows a flow diagram of the “scroll” process of the trading system of one embodiment of the present invention.

FIG. 10 shows a flow diagram of the “converge 1 pixel” process of the trading system of one embodiment of the present invention.

FIG. 11. shows how to place an order with a market depth convergence tool according to one embodiment of the present invention.

FIG. 12 shows how to cancel an order with a market depth convergence tool according to one embodiment of the present invention.

### DETAILED DESCRIPTION OF THE PREFERRED EMBODIMENT

While the present invention is capable of embodiment in various forms, there is shown in the drawings and will be hereinafter described a presently preferred embodiment with the understanding that the present disclosure is to be considered as an exemplification of the invention, and is not intended to limit the invention to the specific embodiment illustrated.

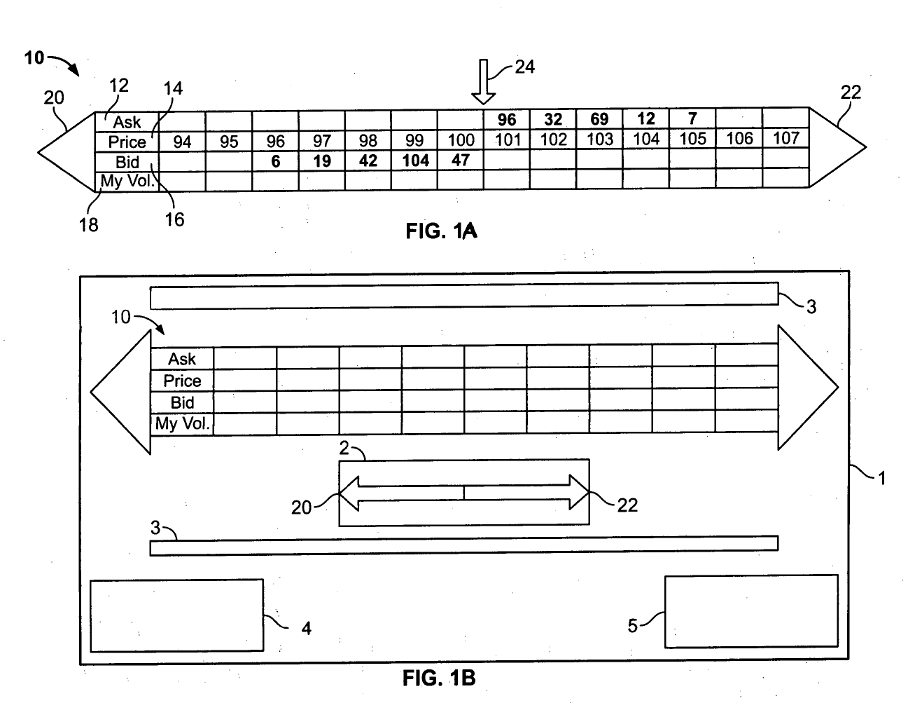

FIG. 1 shows a representative computer screen 1 and a graphical user interface having a market depth convergence tool 10 according to one embodiment of the present invention. The convergence tool 10 includes an ask row 12, a price row 14, a bid row 16 and may advantageously include a “My Vol” row 18. The convergence tool 10 also includes scroll buttons 20 and 22. The scroll buttons 20 and 22 may be included as part of the user interface, as shown in FIG. 1, or may be included in other areas of the screen 1, such as that depicted generally at box 2.

Price row 14 shows a range of prices for a commodity, while the ask and bid rows show the market depth for that commodity at the prices shown in the price row. For instance, in the bid row 16, the number “47” indicates that there are 47 buy contracts at the price of 100. Similarly, in the ask row 12, the number “96” indicates that there are 96 sell contracts at the price of 101. As discussed in more detail below, the “My Vol” row is used to show a numeric quantity that represents unfilled orders by a user at a particular price. The My Vol row 18 may be positioned as shown in FIG. 1 as below the bid row 16 or above the ask row 12, or may also be included in another area of the screen 1, such as, for example, area 3. Advantageously, the precise location of the My Vol row 18 and the form that it takes may also be determined by the user upon the application of user control functions generally shown as box 4. Such user control functions include the ability to adjust screen size, font, color, as well as the positioning and size of the convergence tool 10 and the My Vol row 18.

It will be appreciated that although FIG. 1 only shows a market depth convergence tool 10 and the items associated with boxes 2 and 4 and area 3, other features and functionality, which are well known in the art, can be added to the graphical user interface. For instance, other tools and graphics can be displayed to set trading parameters, such as the commodity being traded and default quantity values, or to show high and low prices, last traded prices, last traded quantity, net position, market volatility, etc. Also, a user may set text size and color attributes, column and row size, color and orientation. Moreover, myriad other buttons and settings (such as pull all buy/sell orders, forced convergence, order type selectors (ie., limit, stop, stop limit, IOC “immediate or cancel”) can be displayed. These other displays/functionalities are generally represented by box 5.

In FIG. 1, the price level that lies directly between the highest price bid (here, 100) and the lowest price offered (here, 101) is the “inside market” price, which may or may not be a valid tradable market price. In a preferred embodiment, each of the ask, price, bid and “My Vol” rows are given different colors so that a user of the convergence tool 10 can easily distinguish between each row. However, it will be appreciated that the present invention is not limited to differently colored rows (or columns) and that the present invention applies to any color scheme, including monochromatic color schemes. It will also appreciated that although horizontal and vertical orientations of market depth convergence tools are shown and described herein, the present invention is not limited to horizontal and vertical orientations. Indeed, any orientation or shape of the convergence tool 10 can be used in the practice of the present invention, including angular, curvilinear and circular orientations, among others.

The convergence tool 10 also includes a convergence point 24, which is a static point on the graphical display established by a user. As explained in more detail below, once the convergence point 24 is established, the central market price (which is the midpoint of a market, defined by the inside market price in a preferred embodiment of the invention) will always move toward the convergence point. In other words, the price row 14 is dynamic and will always adjust and move until the inside market becomes centered on the convergence point 24. It will be understood, however, that while a preferred embodiment of the present invention uses the inside market prices as the central market price, it is within the scope of the present invention that the central market price can be defined in part by other variables in the market, such as the last traded price, opening price or closing price, but a preferred embodiment will always have the inside market price as a component of the central market price.

In a preferred embodiment of the invention, the central market price will begin moving towards the convergence point 24 whenever these two points become separated. This separation can occur, for example, if:

1) There is a change in the bid, offer, or last trade price that results in a change in the inside market price.

2) The system user moves the central market price to another location on (or off) of the graphical display, for instance if the user scrolls the market price using scroll buttons 20 and 22; or

3) The system user moves the convergence point 24 to another location on the graphical interface.

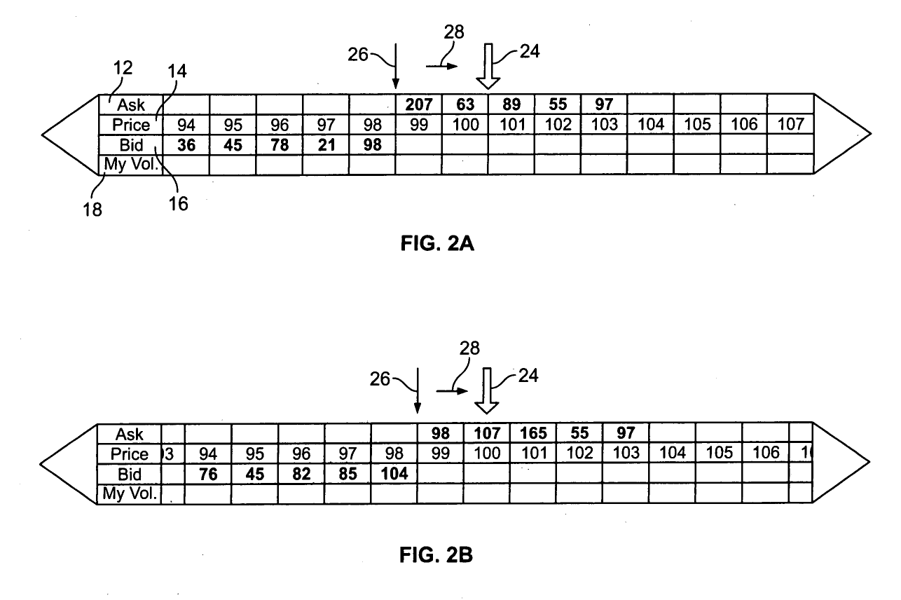

FIG. 2 (with screen 1 removed for clarity) illustrates the movement of the price row 14 in response to a change in the inside market. In FIG. 2a, the inside market has changed from what it was in FIG. 1, in that the highest bid price has shifted from 100 to 98 and the lowest ask price has shifted from 101 to 99. The inside market price shown in FIG. 2a is thus now between 98 and 99, as shown by arrow 26 and is now offset from the convergence point 24. Upon this change in the inside market, the price row 14 immediately starts moving in the direction of arrow 28 to bring the central market price (i.e., the inside market price) into alignment with the convergence point 24. In this sense, the price row 14 is dynamic, in that it always moves in response to a change in the central market price, which is, in a preferred embodiment, the inside market price. As a result of this movement of the price row 14, the relative bid and ask order quantities in rows 12 and 16 also move in order to maintain proper correspondence between the bid/ask orders and their respective prices. FIGS. 2b -2d illustrate the progression of this movement until the inside market price is aligned with the convergence point 24 (FIG. 2d). For example, in FIG. 2b, the bid price is 98 for 104 bid (or buy) contracts of the trading vehicle and the ask price is 99 for 98 ask (or sell) contracts of that vehicle. These data progressively converge on convergence point 24 as seen in FIGS. 2c and 2d. It will be understood that convergence point 24 can be indicated by a visible arrow or other symbol or graphic, as shown in FIGS. I and 2, or can be hidden, depending on a particular user's preference. The same goes for arrows 26 and 28. For example, a change in the inside market results in the automatic appearance of the arrow 26, which reflects the position of the inside market with respect to the convergence point 24 and as the inside market converges on the convergence point, arrow 28 represents that convergence. As explained below, depending on the speed of convergence, the length of the arrow 28 may represent that convergence speed. As noted above, however, the user can configure the screen I using control functions 4 to “hide” any one or more of the point 24 and the arrows 26 and 28. Indeed, while having visible arrows that show the convergence point, the central market price and the movement of the dynamic price row may prove beneficial to some users, others may find that this amount of indicators provides too much clutter on the interface, and therefore may choose to hide one or more of these indicators. User control functions 4 (see FIG. 1) allow the user to configure the visual appearance of the convergence point 24 and arrows 26 and 28. It will also be understood that convergence point 24 may be moved by a user to a desired area on his or her screen by using a “drag and drop” process or by using keyboard commands.

While FIG. 2 shows the inside market and the price row converging on the convergence point from left to right, it will be appreciated that when the inside market moves to a position greater than the location of the convergence point, the inside market and its associated prices will converge on the convergence point from right to left with reference to FIG. 2.

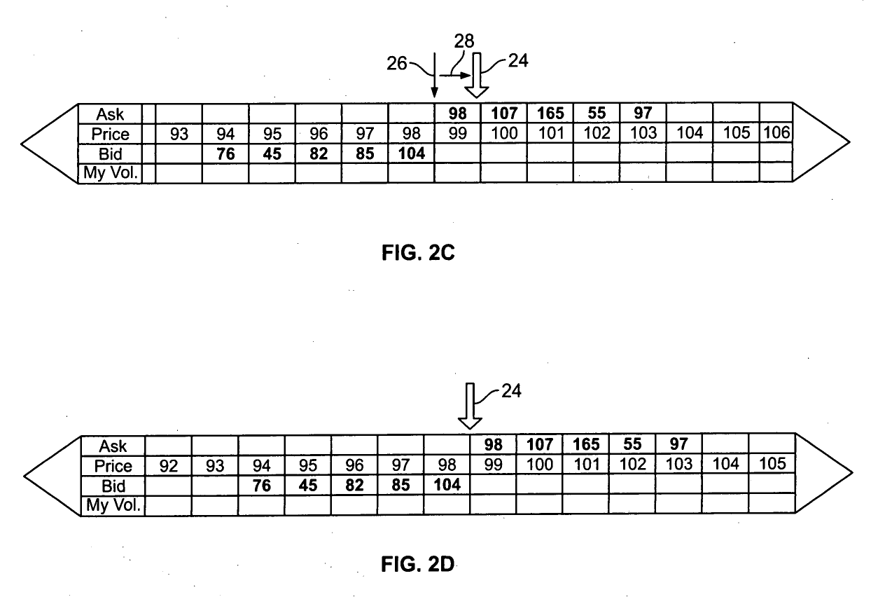

FIG. 3, and in particular FIGS. 3a-3e show a movement of the price row 14 in response to a change in the inside market, except that the market depth tool 10 is now oriented vertically, as opposed to horizontally, with the Bid, Price, Ask and “My Vol” rows being converted to columns. Thus, in FIG. 3, the market depth tool includes a bid column 30, a price column 32, an ask column 34 and a “My Vol” column 36. Also included is a convergence point 38 and scroll buttons 40 and 42. The embodiment of FIG. 3 may also include the functionality associated with the boxes 2, 4 and 5 and area 3 of FIG. 1. As with FIG. 1, the scroll buttons 40 and 42 and the My Vol column 36 of FIG. 3 may be located in another part of the screen one. Also, it will be appreciated that the price, bid and ask column/rows of FIGS. 1-3 may be joined together as shown and may also be separated. Also, the ordering of the price, bid and ask rows may be varied based on user preference.

FIGS. 2 and 3 discussed above represent a divergence in the central market point and the convergence point due to a change in the inside market. As mentioned earlier, the convergence point and the central market price will also diverge if a user scrolls the price column (or row) using scroll arrows 20 and 22 (for a horizontal interface in FIG. 2) or arrows 40 and 42 (for a vertical interface in FIG. 3). A user may want to scroll the price to place an order at a price level above or below the current viewable area. Alternatively, a user may want to pull a working order from the “My Vol” column that has moved out of the current viewable price range.

As with FIGS. 2b -2d, FIGS. 3b-3e depict arrow 39, which reflects the position of the inside market (arrow 39 is comparable to arrow 26 of FIG. 2), with the length of arrow 39 adapted to represent the convergence speed of the inside market toward the convergence point 38.

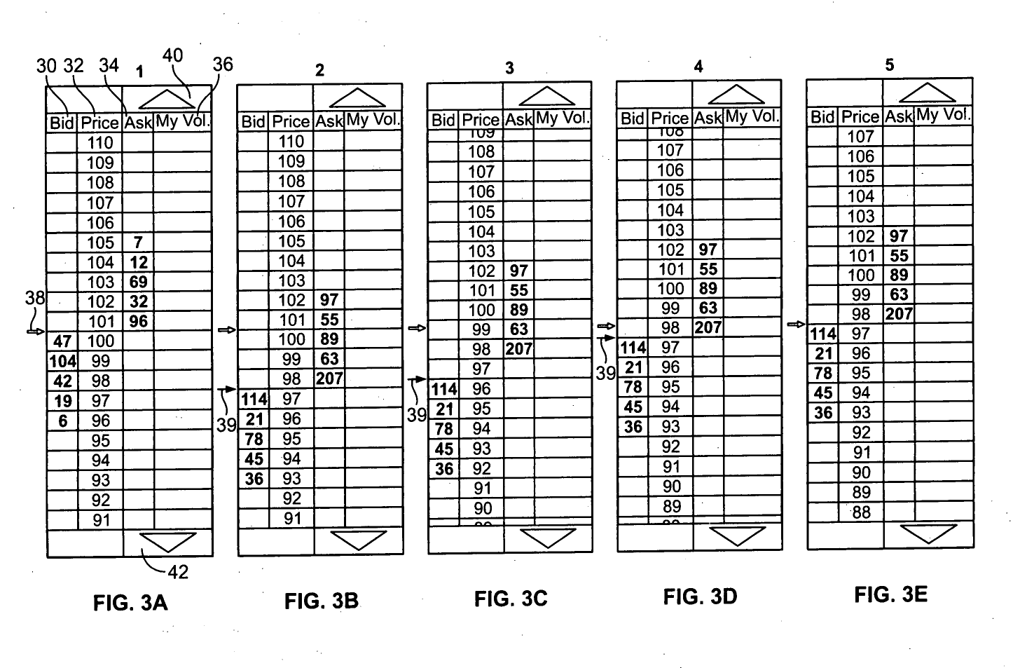

FIG. 4 shows a vertical interface scrolling feature. FIG. 4a shows a manual move in the central market price prompted by clicking the down scroll arrow 42 three times. This results in a corresponding shift in of the price column 32 and corresponding bid and ask columns, 30, 34 by a unit of three full horizontal rows which reveals an order to sell one instrument above the market at a price of 112 (as identified by number 45). The location of the convergence point 38 remains unchanged. When the a user stops clicking the scroll button 42, the central market price 44 then begins to immediately move toward the convergence point 38 in the direction of arrow 46, as shown in FIG. 4b, until the convergence point 38 and central market price 46 are in alignment, as shown in FIG. 4c. While FIG. 4 shows the inside market and the price row converging on the convergence point from bottom to top, it will be appreciated that when the inside market moves to a position greater than the location of the convergence point, the inside market and its associated prices will converge on the convergence point from top to bottom with reference to FIG. 4.

The speed of convergence in one embodiment of the invention can be varied by the user to suit personal preferences by the user control functions 4. Speed is represented as being distance divided by time. The minimum unit of distance that can be displayed on a computer screen is a single pixel. As is known in the art, the actual length and width of a pixel on a computer screen depends on how many vertical and horizontal pixels that the computer hardware and software are capable of displaying (screen resolution) and the actual size of the computer monitor. For purposes of describing the present invention, speed, velocity and acceleration calculations will assume that the minimum distance of potential travel is a single pixel. However, it will be noted that the actual distance for a particular user will vary by his or her actual screen resolution and the size of their monitor and individual preferences set using control functions 4.

It is believed that using a single pixel as the minimum unit of change in a market depth/price display will help to smooth out the motion of the market so that it can be more easily followed by the trader. However, it is within the scope of the present invention that the minimum unit of change can be based on multiple pixel movements in a single action or can be based on other units, such as inches or millimeters. In one embodiment of the invention, the velocity at which the central market price moves towards the convergence point when they are separated can be set by a user as follows. It will be understood, however, that the present invention is not limited to any particular method, algorithm or mathematical formula for calculating a convergence rate.

1) A constant rate of convergence which can be adjusted as a parameter by the system user, using the formula:
S=(P/T)

Where S=Speed, P=Pixels, and T=Time interval. This speed can also be defined by a parameter equal to a number of milliseconds between each pixel move.

2) A non-linear rate of convergence that varies depending on the distance between the central market price and the convergence point. With this setting, the velocity of the central market price toward the convergence point varies by the magnitude of distance between the two points with longer distances resulting in a higher velocity, using the formula:
Vx=((1/K)*(P))/T

Where Vx=Velocity at point x, K=deceleration factor, P=Number of Pixels between two points, and T=Time. In a preferred embodiment, non-integer values are rounded up to the highest integer. A practical way to view velocity at a particular point in time is the number of milliseconds that elapse between each pixel move. There are many ways to decelerate the velocity of the convergence, and in one embodiment is performed using the formula:
Dx=K+((3/P)*2000)

Where Dx yields a delay time interval in milliseconds, K=deceleration factor, P=Number of Pixels between two points, and T=Time.

3) If a change in the central market price occurs during a process of a dynamic convergence which would result in some change of direction of the convergence algorithms can be used to create a smooth and gradual change in direction, in lieu of an abrupt stoppage in movement, followed by a reversal in direction.

As can be appreciated from the above, the described graphical user interface having a market depth convergence tool represents an advanced trading platform that offers the benefits of automatically centering the central market price upon a specified point within a graphical display area in a smooth and fluid motion. In a preferred embodiment, when the central market prices moves away from a defined convergence point on the screen, the central market price and corresponding market price levels in the display will immediately begin to move back towards this defined point. Thus, the inside market is either completely aligned with this convergence point, or it is moving towards it.

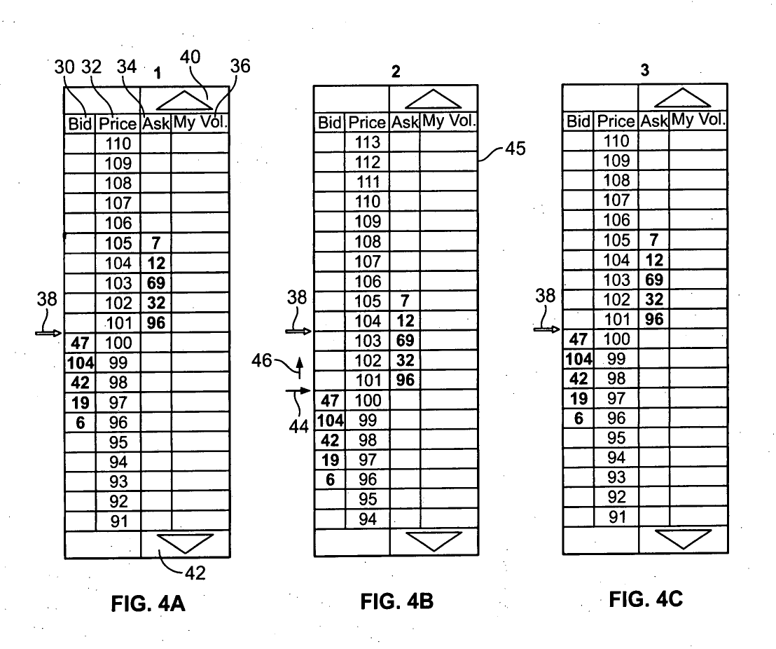

FIG. 5 shows a high level view of what occurs between the time that the interface is launched and the time that it is terminated. When the interface is first launched for a particular commodity, it loads the parameters needed to build the interface including relevant market data and configurable parameters from the system settings, as shown in box 48. Once these parameters are loaded, the values are used to render a graphical display of the market that is dynamically updated as the market changes, as shown in box 50 (the draw market process). The draw market process will render the market within the graphical display based upon the attributes of the market, current market conditions and configurable parameters and settings selected by the component user. Examples of market attributes include the instrument symbol, short description, tick interval, point interval, etc. Examples of current market conditions include last trade, best bid, best offer, bid/offer quantities at various market depths, etc. Examples of configurable parameters include convergence point, color preferences, price continuum orientation preferences (vertical/horizontal, etc.), order of bid, ask, price columns, etc. The draw market process is called when the trading component is initially launched, and any time that there is a change in market conditions, market attributes or user defined settings that would result in a change in the visual orientation, color or size of a defined graphical element of the trading component. The auto convergence mechanism is handled by the monitoring process shown in box 52.

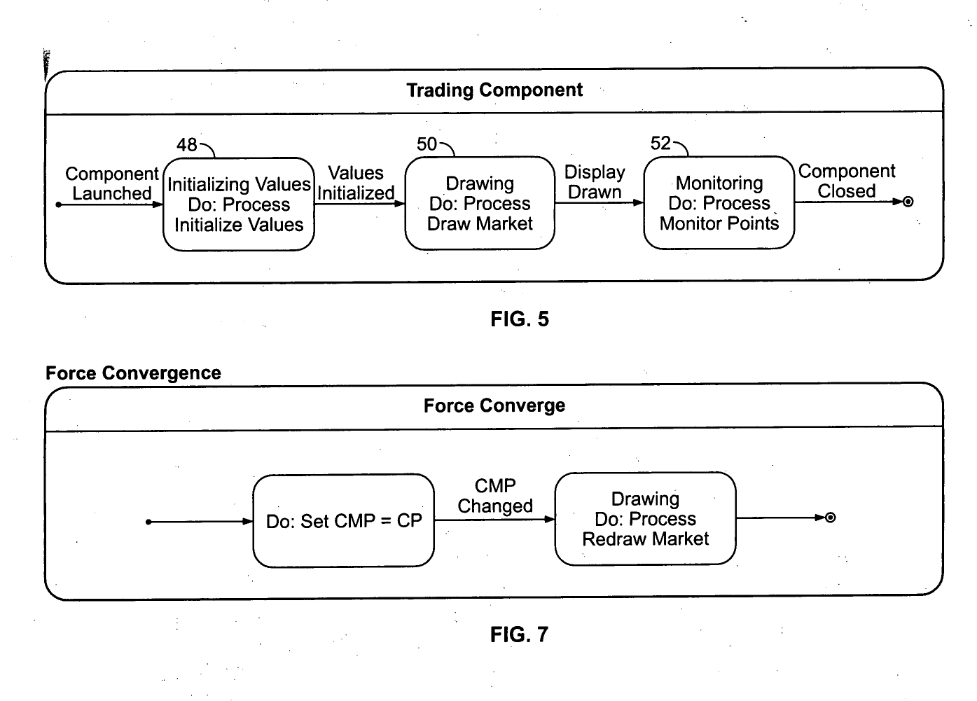

FIG. 6 shows in more detail the monitoring process. The monitoring process is constantly and dynamically monitoring the underlying market for events that would trigger a separation of the central market price from the defined convergence point. As described above, these events are, for example: 1) a change in the inside market price (box 54) 2) a user scrolls the prices (box 56); or 3) a user changes the convergence point (box 58). Any of these events results in a change in value of either the central market price or the convergence point.

The monitoring process shown in FIG. 6 will immediately identify when the location of the central market price (identified as “CMP” in FIG. 6) and convergence point (identified as “CP” in FIG. 6 are out of equilibrium by constantly comparing whether the CMP equals the CP, as shown by box 60. If the CMP does not equal the CP, the program will trigger the process “Converge 1 Pixel” subroutine, shown in Box 62. The monitoring tool will continue to loop through this process until the central market price moves back to the defined convergence point in the display. The convergence motion is preferably smoothed by a delaying each pixel motion by a set or calculated number of milliseconds; however, in a preferred embodiment of the invention, there is no delay on the first pass through the “Converge 1 Pixel” process immediately following any of the three defined trigger events. This gradual convergence is ongoing as long as these the central market price and convergence points are separated. Alternatively, a user can force an instantaneous convergence by clicking in a defined region in the graphical interface and triggering the “Force Convergence” process, shown in box 64.

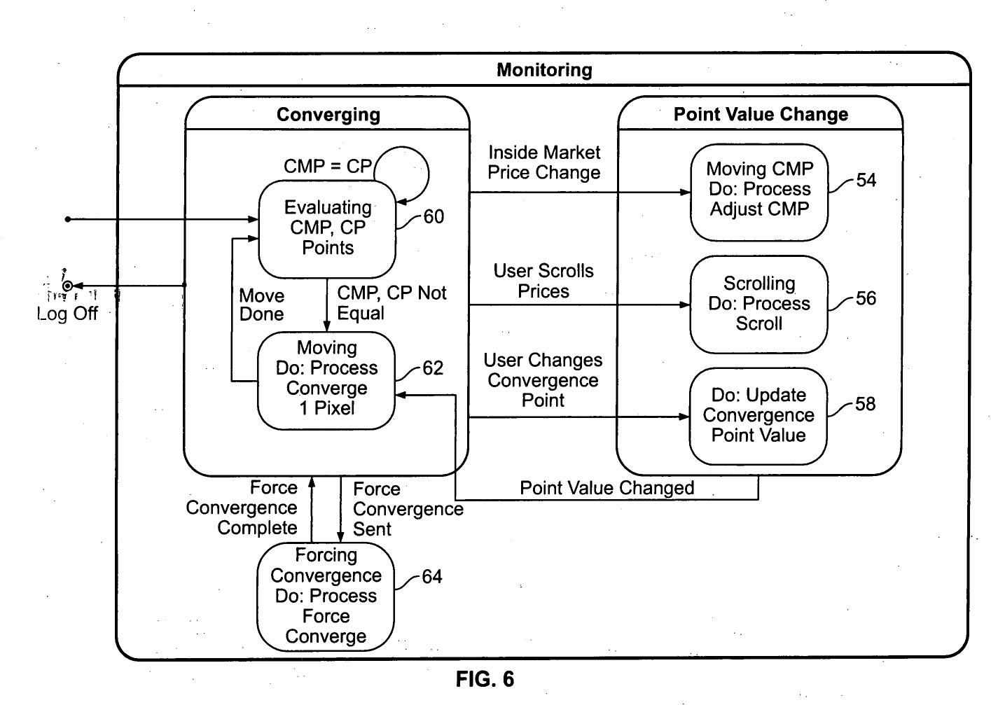

FIG. 7 shows in more detail the subroutine for performing the force converge function 64, which forces an instantaneous convergence of the central market price and the convergence point. In a preferred embodiment of the invention, this process is triggered by a user clicking in a defined region in the graphical interface. Upon such a clicking event, the graphical user interface is instantaneously redrawn so that the central market price is aligned with the convergence point.

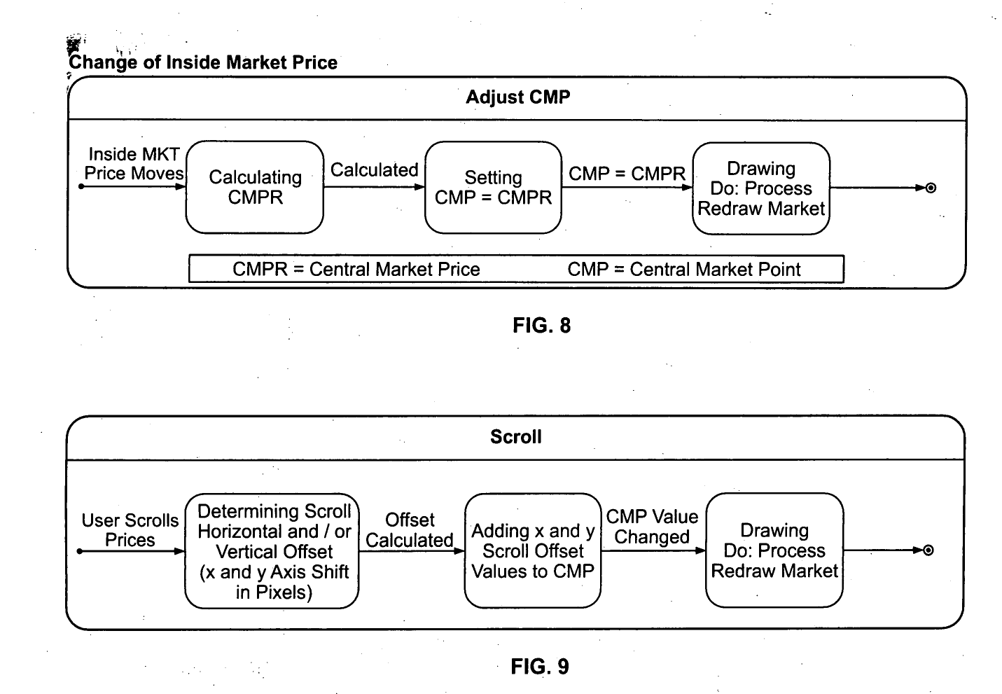

FIG. 8 shows in more detail the subroutine for moving the central market price due to a change in the inside market. When the inside market changes, the central market price is calculated, as detailed below. This calculation results in a central market point being created that corresponds to the central market price. The program then redraws the market to reflect the change in the central market price. The central market price is typically the inside market price, which is calculated by halving the sum of the highest current market bid and lowest current market offer:
(BestBid+BestOffer)/2

However, the calculation of central market price can vary according to a number of factors including user preference, the market mode (close, pre-open, open), and market conditions. When the market mode is open, the central market price will always include the inside market price as a parameter in its calculation. Thus, any change in the inside market price will always result in a change of the central market price when the market is open. When the market mode is closed, there are no current bids and offers on which to calculate the central market price. In this case, the user may choose to set the central market price equal to the last trade price, the exchange settlement price or an average of the best bid/offer at the close. When the market mode is “Pre-Open”, bids and offers can be entered anywhere along the price continuum. Bids that exceed offers (and vice-versa) will not be executed until the market opens. Thus during pre-open, market bids can exceed market offers. During this time, a trader may choose alternative methods of calculating the central market point including previous settlement price, market opening guess (ie., at what price would the market open if it were to open with current bids and offers in the depth, etc.). During this time the trader may also choose to select an arbitrary central market price based on his view of where he thinks the market will actually open. Finally, a trader may want to bias the calculated central market price based upon some other value. For markets that are very illiquid, the best bid and offer can be multiple price levels apart. If the highest volume of trades is occurring closer to the bid price than the offer, the trader might want to bias the calculated central market price to be closer to the bids than the offers. This would give a visual cue that the actual market clearing rate (i.e., the price where buyers and sellers are actually trading) is somewhere closer to the current bid than the current offer. This can be done by incorporating the last trade price into the central market price calculation. An example would be:
Central Market Price=(0.5*Inside Market Price)+(0.5* (Avg of Last 2 Trade Prices))

Assuming best bid=95, best offer=105 and last 2 trade prices are 103, 104 the calculation would be:
Inside Market Price=(95+105)/2=100
Average of last 2 Trade Prices=(103+104)/2=103.5
Central Market Price=(0.5*100)+(0.5*103.5)=101.75

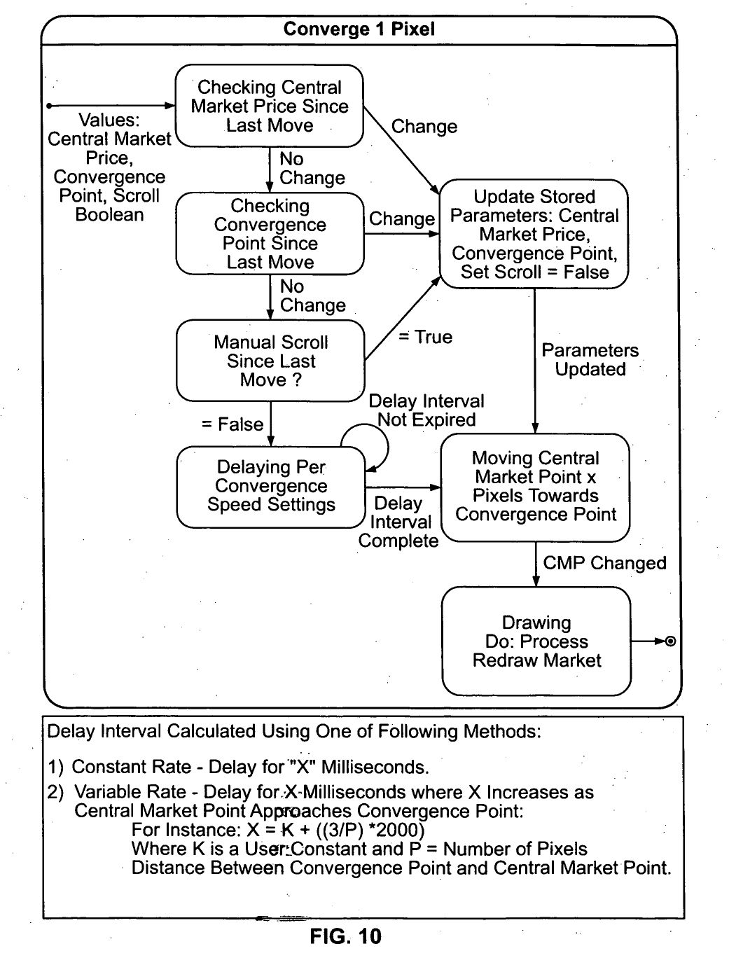

FIG. 9 shows in more detail the scrolling subroutine. When a user clicks on a scroll button, the program determines how much of a pixel shift, or offset, there is in the x or y axis (depending on whether there is a vertical or horizontal display). Using this offset, the program adds the pixel shift to the location of the central market price, which results in the central market price being shifted on the screen along the x or y axis once the program redraws the screen to reflect this shift.

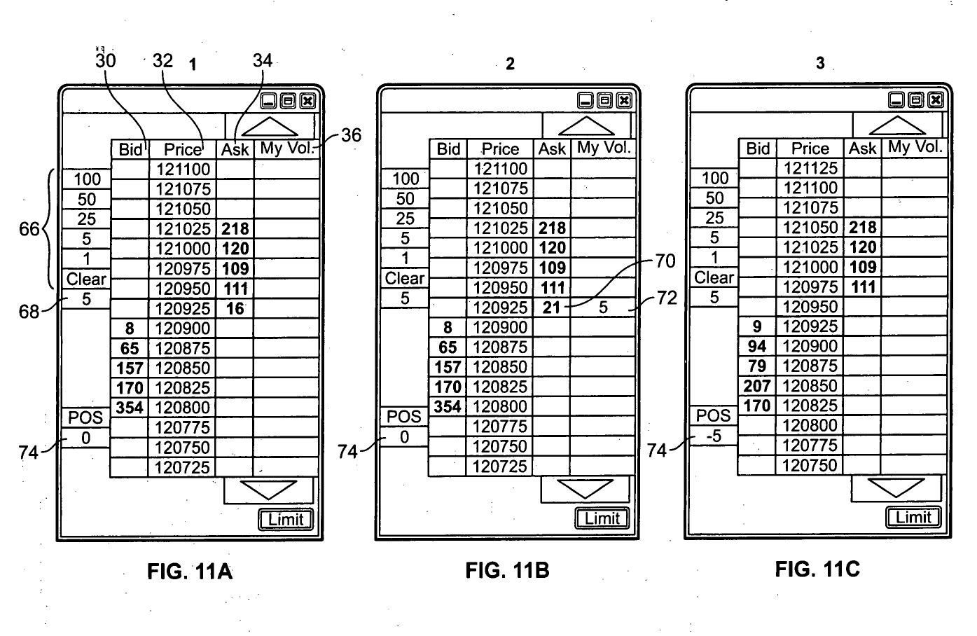

FIG. 10 shows in more detail the “Converge 1 Pixel” subroutine. The monitoring process will immediately identify when the CMP and CP are out of equilibrium. When this condition is identified (CMP and CP not equal) the process “Converge 1 Pixel” is triggered. The monitoring process will continue to loop through the “Converge 1 Pixel” process until the central market price and convergence point are equal and in alignment on the graphical display. The Converge 1 Pixel process performs the calculations that govern the speed of the actual convergence of the CP and CMP, managing the rate of change in the CMP. In the preferred embodiment of this process, any change in the inside market price will result in an immediate change in the CMP, followed by an immediate, but gradual convergence of this point back to the CP. Although in one embodiment this actual convergence occurs one pixel at a time, the movements happen in rapid succession. Thus, from a user perspective, it appears as a smooth and fluid movement of prices to a central point of focus where the inside market price converges with the convergence point. When the Converge 1 pixel subroutine is first triggered, it checks to see if any events have occurred since the last pixel of convergence that would affect the delay interval, and in particular looks for a change in three specific items: 1) Did the Central Market Price change since the last time this process was run?; 2) Has the Convergence Point moved since the last time this process was run?; and 3) Has a scroll command been issued by the user since the last time this process was run? These conditions are checked by comparing current parameter values which are passed into the process each time it is run against reference values that are stored within this process. If any of these three conditions are true, then the updated reference values for these three parameters are stored and the delay interval for this pixel movement is skipped. Skipping the delay interval upon a change in these three conditions ensures that a change in the central market price results in an immediate movement of prices to the convergence point. Once the central market price is moved, the “Redraw Market” process is called to render the movement on the graphical display. Following the movement, the points are evaluated again by the monitoring process which will continue to loop through the “Converge 1 Pixel” process until the CMP and CP are equal and in alignment on the graphical display.

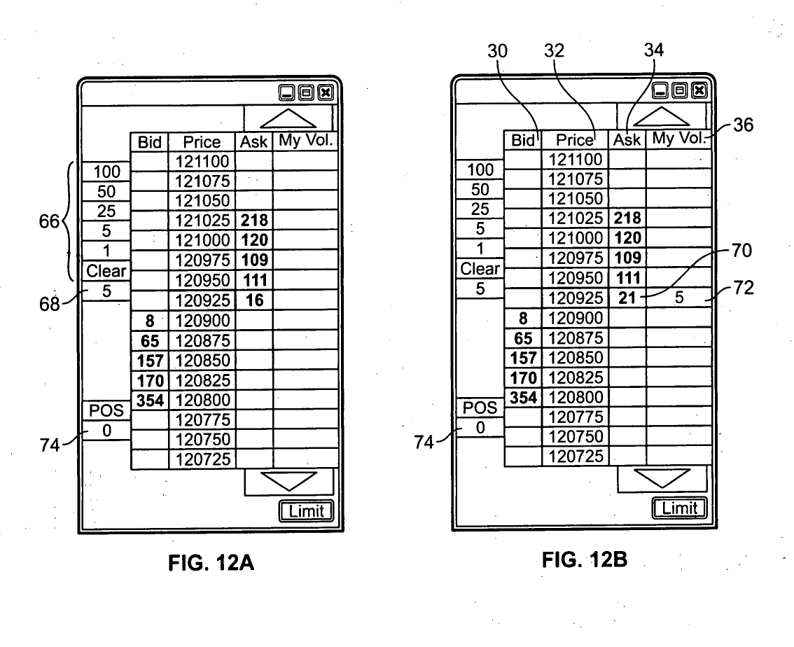

FIG. 11 shows how trades can be made with one embodiment of the present invention. As an overview, a trader can place a trade by specifying a trade quantity and single clicking the left mouse button on a region of the graphical interface that corresponds with his or her desired trade price within the market depth display. It should be noted that as the term “single clicking” or “single click” as used herein means a single action by a user or a number of actions by a user within a short period of time. Thus, for example, a double-clicking action or a single click followed by another single click in a confirmation screen would all be considered a “single click”. Also, it will be appreciated that even though a preferred embodiment of the invention contemplates actions by a user using a left click button of a mouse, it is within the scope of the invention that any mouse button or other input device (such as a keyboard, track ball, touch pad, etc.) can be used to execute orders and send commands to the trading software.

If the order is unfilled, it will be shown as a numeric quantity in an area that corresponds with its price and position in the market depth within the price display (“My Vol” column). The trader can cancel or pull this order from the market by positioning their mouse pointer over the numeric quantity that represents their order in the “my vol” column and single clicking the left mouse button. The single click order place and order pull functions are illustrated in FIGS. 11a-11c.

FIG. 11a shows the trader selecting an order quantity of five by left mouse clicking the “5” in the column of order volume buttons 66. This quantity is confirmed by the display region 68 below the column 66, which displays the number “5”. In FIG. 11b, a sell order is shown being submitted into the market with a price of 120925 by left mouse clicking into a cell 70 corresponding to that price in the market depth in the “ask” column. The order joins the other orders offered at that price, and the total quantity offered for the price 120925 increases from “16” (shown in FIG. 11a) to “21”, shown in FIG. 11b. The number “5” that appears in the cell 72 to the right of the ask quantity in the “my vol” column 36 represents the portion of the total market depth that belongs the trader (i.e. his working order to sell 5 contracts).

In FIG. 11c, the market is shown to be bid at 120925, which is sufficient to fill the sell order that the trader has working in the market. The position (“POS”) window 74 shows a value of −5 which indicates that the trader is now short 5 contracts. The quantity in the “my vol” column 36 is removed when the order is filled.

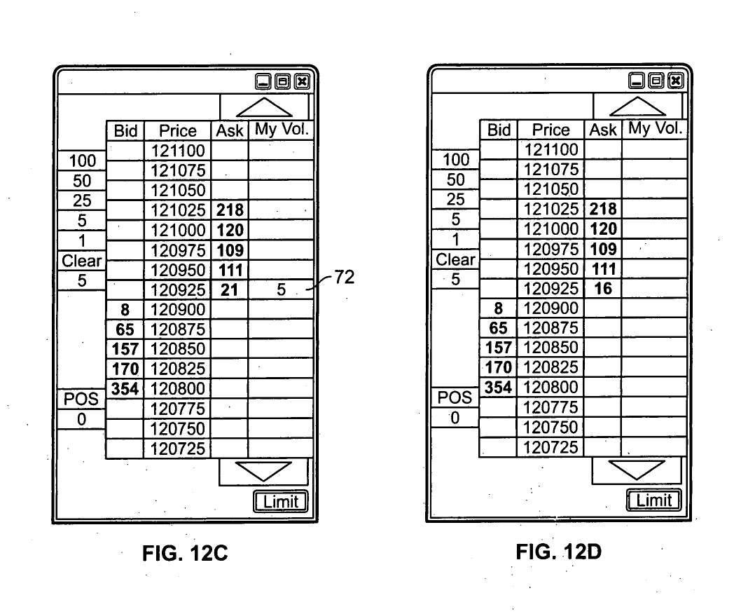

FIG. 12 shows how trades can be canceled in one embodiment of the present invention. First, an order quantity of 5 is selected by a left mouse click on the order volume buttons 66. This quantity is confirmed in display region 68. Second, the trader joins the offer at the price of 120925 by left mouse clicking in cell 70, which corresponds to that price in the market depth “ask” column. As shown in FIG. 12b, the ask quantity jumps from 16 to 21 and the traders working order quantity of 5 appears in cell 72 the “my vol” column 36. In order to cancel the order, the trader simply places the mouse over the order quantity display of “5” in the “my vol” column 36 in cell 72 and clicks the left mouse button to cancel the order, as shown in FIG. 12c. FIG. 12d shows the working order quantity removed from the “my vol” column 36, confirming that the order is canceled.

The foregoing description of a preferred embodiment of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined by the claims set forth below.

What is claimed is:

1. A trading system having a graphical user interface, comprising
a first axis showing a plurality of prices for a given trading vehicle;
a second axis showing a plurality of bids corresponding to the prices on the first axis;
a third axis showing a plurality of asks corresponding to the prices on the first axis;
a convergence point on said graphical user interface, wherein when there is a change in the inside market, said first axis moves so that a price associated with the inside market gradually becomes aligned with said convergence point.

2. The trading system of claim 1, wherein the price associated with the inside market is the average of the price corresponding to the highest current bid and the price corresponding to the lowest current ask.

3. The trading system of claim 1, wherein the price associated with the inside market is determined in part by at least one variable selected from the group consisting of user preference, the market mode, and market conditions.

4. The trading system of claim 1, further comprising a fourth axis showing a trader's market position corresponding to the prices on the first axis.

5. The trading system of claim 1, wherein said convergence point is indicated by a visible symbol.

6. The trading system of claim 1, wherein said first axis is oriented horizontally.

7. The trading system of claim 1, wherein said first axis is oriented vertically.

8. The trading system of claim 1, wherein said price associated with the inside market is the central market price.

9. The trading system of claim 1, wherein the trading system is adapted to place a trade in response to a single click of a user input device.

10. The trading system of claim 1, further comprising user control functions comprising the ability to adjust aspects of said graphical user interface.

11. The trading system of claim 1, further comprising user control functions comprising the ability to set trading parameters.

12. The trading system of claim 1, wherein said first axis and said second axis are of different colors.

13. The trading system of claim 1, wherein the rate of said movement of the first price axis when there is a change in the inside market is constant.

14. The trading system of claim 1, wherein the rate of said movement of the first price axis when there is a change in the inside market is determined by an algorithm adapted to gradually change the direction of said movement when a change occurs that would result in a change of direction of said first axis.

15. The trading system of claim 1, wherein the rate of said movement of the first price axis when there is a change in the inside market is determined in part by the distance between said convergence point and said price associated with the inside market.

16. The trading system of claim 1, wherein the rate of said movement of the first price axis can be adjusted by the user.

17. A trading system display, comprising:
a dynamic display having a graphical user interface responsive to input from a user input device, said display including an area displaying a plurality of axes, said plurality of axes comprising a price axis adapted to display a plurality of prices for at least one trading vehicle, a bid axis adapted to display a range of bids and showing at least one bid for said at least one trading vehicle, said at least one bid being associated with a first price of said prices on said price axis, and an ask axis adapted to display a range of asks and showing at least one ask for said at least one trading vehicle, said at least one ask being associated with a second price of said prices on said price axis, with the lowest price associated with an ask and the highest price associated with a bid defining a region of said price axis representative of the inside market of said at least one trading vehicle;
a convergence point positionable, adjacent said plurality of axes, by a user of said trading system display,
said price axis adapted to move in the direction of said convergence symbol response to a change in the inside market of said at least one trading vehicle until said region is aligned with said convergence point.

18. The trading system display of claim 17, further comprising:
a first area displaying information definable by a user of the trading system, such information relating to the vehicle being traded and including one or more of an identification of the vehicle being traded, the open price for said vehicle, the prior trade day close price for said vehicle, the last traded price, the last traded quantity, the user's ask position, the user's bid position, and the user's net position, and
a second area adapted to receive input from said user input device to effect at least one of the following actions: delete a predefined number of bid orders, delete a predefined number of ask orders, predefine a volume of bid orders, predefine a volume of ask orders, limit bid order volume in response to the inside market, limit ask orders in response to the inside market, initiate a predefined ask order in response to the inside market, and initiate a predefined bid order in response to the inside market.

19. A method for displaying information regarding a market in a graphical user interface, comprising:
displaying a first axis showing a plurality of prices for a given trading vehicle;
displaying a second axis showing a plurality of bids corresponding to the prices on the first axis;
displaying a third axis showing a plurality of asks corresponding to the prices on the first axis;
monitoring the market for events that trigger a separation of a convergence point on the graphical user interface from a price associated with the inside market; and
gradually aligning said price associated with the inside market with said convergence point.

20. The method of claim 19, further comprising displaying fourth axis showing a trader's market position corresponding to the prices on the first axis.

21. The method of claim 19, further comprising placing a trade in response to a single click of a user input device.

22. The method of claim 19, wherein said price associated with the inside market is the central market price.

23. The method of claim 19, wherein said price associated with the inside market is gradually aligned with said convergence point at a constant rate.

24. The method of claim 19, wherein said price associated with the inside market is gradually aligned with said convergence point at a rate adjustable by the user.
